(19) United States
(12) Patent Application Publication
(10) Pub. No.: US 2009/0090612 A1
(43) Pub. Date: Apr. 9, 2009

(54) Device for producing a purified liquid from an uncleaned liquid

(75) Inventor: Kurt Hausmann, Konigsbrunn (DE)

Correspondence Address: BACON & THOMAS, PLLC, 625 SLATERS LANE, FOURTH FLOOR, ALEXANDRIA, VA, 22314-1176, US

(73) Assignee: KBH Engineering GmbH, Konigsbrunn (DE)

(21) Appl. No.: 11/919,987

(22) PCT Filed: Apr. 13, 2006
(86) PCT No.: PCT/EP2006/003406

§ 371 Date: Nov. 6, 2007

(30) Foreign Application Priority Data
May 6, 2005 (DE) 20 2005 007 278.8

(51) Int. Cl. C02F 1/04

(52) U.S. Cl. 202/185.1

(57) ABSTRACT

A device for producing a purified liquid from an uncleaned liquid has at least one evaporator (10) for evaporating the supplied uncleaned liquid, and at least one condenser (23) for condensing the supplied steam, each condenser (23) being connected to the steam outlet of at least one upstream evaporator (10) by a connection pipe (47). A pressure difference is provided between the evaporator (10) and the condenser (23). In order to also generate energy, besides producing the purified liquid, at least one steam-operated working machine (70) to which the steam which can be supplied to the condenser (23) can be applied, is associated with the connection pipe (47).

This invention relates to a device for producing clean liquid from untreated liquid, in particular for producing fresh water from salt water, having at least one evaporation device for evaporating raw water which can be supplied thereto, and further having at least one condensation device for the condensation of the vapour supplied, which condensation device is connected with the vapour outlet of at least one upstream evaporation device via a connecting line, with a pressure difference provided between the evaporation device and the condensation device.

Such a device is known from DE 102 60 494 B3. In this known arrangement, the evaporation device and the condensation device are evacuated for the purpose of obtaining a low boiling temperature. The condensation occurring in the region of the evaporation, however, will on the evaporation side result in a certain increase in pressure relative to the condensation device. This pressure difference has not been used as yet.

On the basis of the foregoing it is the object of the present invention to improve a device as described initially above by simple and low-cost means in such a way that not only clean liquid can be produced but also energy generated.

According to the invention, this object is achieved in that in the arrangement described above the connecting line between the evaporation device and the condensation device is associated with at least one steam driven prime mover which can be supplied with the steam supplyable to the condensation device.

This ensures that the pressure difference between the evaporation device and the condensation device can be used to generate energy, with the increase in volume also resulting in an improved subsequent condensation.

Advantageous embodiments and expedient developments of the main-claim measures will be evident from the sub-claims. Thus, the prime mover supplyable with steam may be expediently designed as a steam engine, preferably a diaphragm steam engine having two separate operating chambers which are separated by a movable operating element preferably provided with a thrust and a pull element, which operating chambers can be alternately connected with the evaporation device or the condensation device by means of a control valve. Advantageously, this results in a double-acting steam engine.

It may be advantageous to control the steam supply to the prime mover in such a manner that the steam supply to the expanding operating chamber is interrupted before the latter has reached its largest volume, which permits expansion of the steam and thus an improved degree of efficiency.

A further expedient measure may consist in the control valve being designed as a sliding valve which can be actuated by means of the movable operating element. In this manner, the steam engine is practically self-controlled.

Advantageously, the prime mover may be associated with a generator for generating electric energy, which may be driven by the prime mover.

Further advantageous embodiments and expedient developments of the main-claim measures will be evident from the remaining sub-claims and can be derived from the description of an example given below in conjunction with the accompanying drawing.

In this drawing

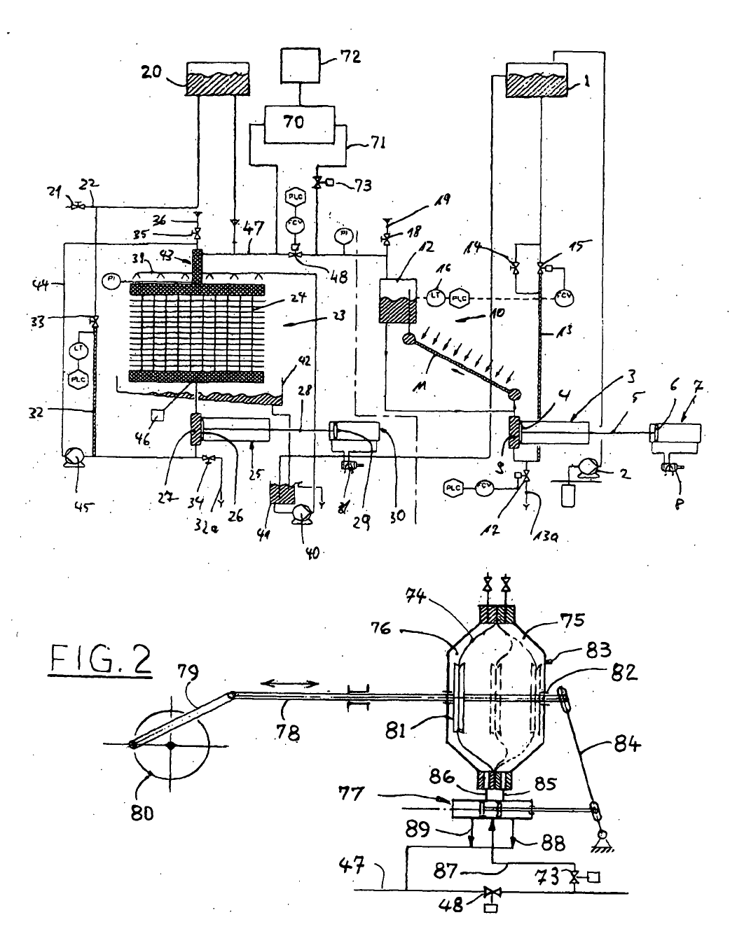

FIG. 1 shows a functional diagram of a seawater desalination plant proposed by the invention and

FIG. 2 shows an example of the prime mover indicated in FIG. 1.

The present invention is mainly used for seawater desalination, that is to say for producing fresh water from salt water, while at the same time electric energy is generated.

Arrangements suitable for this purpose comprise an evaporator side and a condenser side. FIG. 1 contains a dot-dash separation line A, with the evaporator side on the right-hand side of such line, and the condenser side on the left-hand side thereof. The evaporator side comprises an evaporation device 10 which can be evacuated by means of an associated evacuation device 3. The evaporation device 10 comprises a heater 11 which in this example is designed as a solar collector, and, downstream thereof, a separator 12 for separating the vapour from water. The pressure reduction which is achievable by means of the evacuation device 3 results in a low boiling temperature, so that the amount of energy supplyable to the water with the aid of the heater 11, which is designed as a solar collector, is entirely sufficient for evaporation. The salt water is provided in a raw water tank 1 at a higher level, which is supplyable with salt water by means of a pump 2, with the salt water taken, for example, from the sea.

On the condenser side 23 provision is made for a condensation device 23, in this example comprising a condenser 24 designed as a multitubular condenser, and a cooling device 39 which may be designed as a spray device supplyable with raw water. Associated with the condenser 24 is an evacuation device 25 which may cause a pressure reduction in the interior of the condenser 24 supplyable with vapour. The clean water collecting in the condenser 24 is received by a clean water tank 20 which, like the raw water tank 1, is provided on a higher level.

The evaporation device 10 is connected with the condensation device 23 by a connecting line 47 leading from the vapour exit of the separator 12 to the vapour inlet of the condenser 24. The connecting line 47 can be provided with a shut-off valve 48. To start the plant according to the invention, the evaporation device 10 is filled with raw water and the condensation device 23 is filled with clean water. Then, the volume is increased with the aid of the evacuation devices 3 and 25 without aeration, which results in a pressure drop. Due to this, as mentioned on an earlier occasion, a low boiling temperature is brought about. The vapour thus generated, due to its tendency to expand, flows from the evaporation device 10 via the connecting line 47 to the condensation device 23 where it condenses to water.

The design and method of operation of the device described up to this point have been described in detail in DE 102 60 494 B3 which has been mentioned above, to which reference will be made in order to avoid repetitions.

Due to the increase in volume, the evaporation taking place in the evaporation device 10 causes a certain increase in pressure, which results in the previously mentioned pressure difference between evaporation device 10 and condensation device 23. If the amount of energy supplied by the heater 11 is sufficiently large, a lower degree of evacuation might be provided on the evaporator side than on the condenser side from the very beginning. According to the invention, the pressure difference thus caused between evaporation device and condensation device is used to generate energy.

For this purpose, provision is made for a prime mover 70, merely schematically indicated in FIG. 1, which is arranged in an associated loop 71 of the connecting line 47, so that the vapour flowing from the evaporation device 10 to the condensation device 23 flows via the prime mover 70. With the aid of the prime mover 70, a machine 72 can be driven which is also merely schematically indicated in FIG. 1. The machine 72 may expediently be a generator for generating electric energy.

In the example illustrated, the loop 71 is designed as a secondary loop which branches off and re-enters the connecting line 47 and which can further be selectively interposed into the flow path of the vapour. The fittings of the loop 71 are provided in front of and behind the above mentioned shut-off valve 48 which is associated with the connecting line 47. A further shut-off valve 73 is provided in the loop 71, expediently in the upstream branch thereof. If the shut-off valve 48 is shut and the shut-off valve 73 is open, the flow path of the vapour leads via the loop 71. In the reverse case, the vapour does not flow via the loop 71, but without the deviation through the prime mover 70 directly to the condenser 24. The evaporation device 10 and the condensation device 23 are evacuated separately from each other. For this purpose, both shut-off valves 48 and 73 are shut. The shut-off valves 48 and 73, are in an advantageous manner controllable automatically. Expediently, they are designed as valves which are controllable by means of a central control unit. For simple cases, however, manual control would of course be equally conceivable.

The prime mover 70 may be a steam turbine. Expediently, the prime mover 70 is designed as a steam engine in the form of a piston or diaphragm steam engine. However, preference is to be given to a diaphragm steam engine. A corresponding embodiment thereof is the subject of FIG. 2.

The diaphragm steam engine, shown in FIG. 2, comprises two operating chambers 75, 76 which are separated by a flexible element, in this example a diaphragm 74, and which can reversely be extended or reduced in size. The operating chambers 75, 76 can alternately be connected with the evaporation device 10 or the condensation device 23 by means of an associated control valve 77 and can thus reversely be extended or reduced in size. This results in the diaphragm 74 bulging to the one or the other side. In FIG. 2, an end position is indicated by solid lines and an opposite end position as well as a middle position shown by broken lines.

The oscillating movement of the diaphragm 74 is used for driving the machine 72. For this purpose, the diaphragm 74 is connected with a bolted rod 78 acting together with a connecting rod 79 which in turn actuates a crank 80 associated with the machine 72. The rod 78 forming a thrust and a pull element, as has been previously mentioned, is connected with the diaphragm 74 by flanges 81 receiving the diaphragm 74 between them, and is guided on both sides out of the housing 83, which accommodates the diaphragm 74, via sealed guide devices 82 provided in the opposing walls extending transverse to the axis of the rod of the housing 83.

Expediently, the control valve 77 is designed as a sliding valve whose sliding member is movable by the diaphragm 74. For this purpose, provision is made for a rocker lever 84 which is on one side connected with the rod 78 and on the other side with the sliding member of the sliding valve forming the control valve 77. The housing of the aforementioned valve comprising the sliding member possesses two connections 85, 86 associated with the operating chambers 75, 76, and three connections 87, 88, 89 associated with the connecting line 47. The said connections 86 to 89 are provided, and the sliding member of the valve 77 is designed in such a manner that one operating chamber 75 and 76, respectively, is connected with the evaporation device 10 and the respective other operating chamber 75 or 76 is connected with the condensation device 23 and that in each end position of the diaphragm 74 a switchover takes place. This results in a double-acting steam engine, with the movements of the rod 78 to one side and to the other side being effected by steam pressure.

The steam supply to the extending operating chamber 75 or 76, respectively, is expediently controlled in such a manner that the steam supply stops before the respective operating chamber 75 or 76 has reached its largest volume and the movable operating element, in this example the diaphragm 74, has reached its end position. The remaining stroke can then be effected by the expansion of the steam, which has a positive effect on the achievable degree of efficiency. To stop the steam supply at least at half the stroke length, is a preferred measure. In order to interrupt the steam supply, the control valve 77 may be designed and actuated correspondingly. For this purpose, it may be preferable to design and actuate the control valve 73 associated with the loop 71 accordingly. The control valve 73, as has been mentioned above, is preferably designed as an automatically controlled valve controllable by a central control device.

It may be expedient to design the machine 72, as has been previously mentioned, as a generator with the aid of which electric current can be generated and fed into the power grid.

1-15. (canceled)

16. A device for producing clean liquid from untreated liquid, in particular for producing fresh water from salt water, having:
at least one evaporation device for evaporating raw water which can be supplied thereto, said at least one evaporating device including a vapor outlet;
at least one condensation device for the condensation of the vapour supplied, which condensation device is connected with said vapor outlet of said at least one upstream evaporation device via a connecting line, wherein said evaporation device and said condensation device are evacuatable, and a higher pressure is provided in said evaporation device than in said condensation device;
a control valve; and
at least one steam driven prime mover which can be supplied with the steam supplyable to said condensation device, which prime mover is designed as a diaphragm steam engine having two separate operating chambers which are separated by a diaphragm connected with a thrust and a pull element, wherein:
said operating chambers can be alternately connected with said evaporation device or said condensation device by means of said control valve; and
said connecting line is associated with said at least one steam driven prime mover.

17. The device in accordance with claim 16, wherein:
said evaporation device and said condensation device can be mutually shut off and evacuated separately from each other and are connectable with each other in evacuated condition.

18. The device in accordance with claim 16, wherein:
a lower degree of evacuation is provided in said evaporation device than in said condensation device.

19. The device in accordance with claim 16, further having:
a heating device associated with said evaporation device.

20. The device in accordance with claim 16, further having:
a cooling device associated with said condensation device.

21. The device in accordance with claim 16, wherein:
the steam supply to said expanding operating chamber is interrupted before it has reached its largest volume.

22. The device in accordance with claim 16, wherein:
said control valve is designed as a sliding valve possessing two connections associated with said operating chambers and three connections associated with said connecting line.

23. The device in accordance with claim 16, wherein:
said control valve is actuatable by means of said diaphragm.

24. The device in accordance with claim 16, wherein:
said prime mover is provided in a loop of said connecting line.

25. The device in accordance with claim 24, wherein:
loop can be shut off by an associated shut-off valve; and said connecting line in the area between the connections of said loop can be shut off by a further, associated shut-off valve.

26. The device in accordance with claim 25, wherein:
said at least the shut-off valve associated with said loop is controllable automatically.

27. The device in accordance with claim 21, wherein:
said shut-off valve is controllable in such a manner that the connection between said expanding operating chamber and said condensation device is interrupted before the operating chamber has reached its largest volume.

28. The device in accordance with claim 16, a machine, preferably in the form of an electric generator, is drivable by said prime mover.
